(19) United States
(12) Patent Application Publication
(10) Pub. No.: US 2017/0280457 A1
(43) Pub. Date: Sep. 28, 2017

(54) Method and Network Node for Managing Uplink Resources to be Used by a Wireless Device

(71) Applicant: Telefonaktiebolaget LM Ericsson (publ), Stockholm (SE)

(72) Inventors: Jan Christoffersson, Luleå (SE); Zhang Zhang, Beijing (CN)

(21) Appl. No.: 15/528,633

(22) PCT Filed: Dec. 15, 2014
(86) PCT No.: PCT/SE2014/051505

§ 371 Date: May 22, 2017

(51) Int. Cl. H04W 72/04; H04W 52/14; H04W 52/34

(52) U.S. Cl. CPC H04W 72/0473; H04W 52/34; H04W 52/146

(57) ABSTRACT

A method and network node (130; 110; 111) for managing uplink resources to be used by a wireless device 120. Cells (115, 116) for serving the wireless device (120) form at least one imbalance region (117) in which the wireless device (120) has the best quality in the downlink to a first cell (115) of a first type and in the uplink to a second cell (116) of a different, second type. The network node (130; 110; 111) identifies (301; 501) a situation associated with a risk for undesired decrease of transmit power used by the wireless device (120) when the wireless device (120) moves in the imbalance region (117). The network node (130; 110; 111) provides (302; 502), in response to the identification, an adjustment and/or record of a load in the uplink between the wireless device (120) and the first cell (115) and use of said adjusted and/or recorded load for determining one or more uplink resources to be used by the wireless device (120).

### TECHNICAL FIELD

Embodiments herein relate to a method and a network node in a wireless communication network, e.g. telecommunication network, for managing uplink resources to be used by a wireless device.

### BACKGROUND

Communication devices such as wireless devices may also be known as e.g. user equipments (UEs), mobile terminals, wireless terminals and/or mobile stations. A wireless device is enabled to communicate wirelessly in a cellular communication network, wireless communication system, or radio communication system, sometimes also referred to as a cellular radio system, cellular network or cellular communication system. The communication may be performed e.g. between two wireless devices, between a wireless device and a regular telephone and/or between a wireless device and a server via a Radio Access Network (RAN) and possibly one or more core networks, comprised within the cellular communication network. The wireless device may further be referred to as a mobile telephone, cellular telephone, laptop, Personal Digital Assistant (PDA), tablet computer, just to mention some further examples. The wireless device may be, for example, portable, pocket-storable, hand-held, computer-comprised, or vehicle-mounted mobile device, enabled to communicate voice and/or data, via the RAN, with another entity, such as another wireless device or a server.

The cellular communication network covers a geographical area which is divided into cell areas, wherein each cell area is served by at least one base station, or Base Station (BS), e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. Cells may overlap so that several cells cover the same geographical area. By the base station serving a cell is meant that the radio coverage is provided such that one or more wireless devices located in the geographical area where the radio coverage is provided may be served by the base station. When a wireless device is said to be served in or by a cell this implies that the wireless device is served by the base station providing radio coverage for the cell. One base station may serve one or several cells. Further, each base station may support one or several communication technologies. The base stations communicate over the air interface operating on radio frequencies with the wireless device within range of the base stations.

In some RANs, several base stations may be connected, e.g. by landlines or microwave, to a radio network controller, e.g. a Radio Network Controller (RNC) in Universal Mobile Telecommunication System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communication (originally: Groupe Special Mobile).

In 3rd Generation Partnership Project (3GPP) Long Term Evolution (LTE), base stations, which may be referred to as eNodeBs or eNBs, may be directly connected to other base stations and may be directly connected to one or more core networks.

UMTS is a third generation mobile communication system, which may be referred to as 3rd generation or 3G, and which evolved from the GSM, and provides improved mobile communication services based on Wideband Code Division Multiple Access (WCDMA) access technology. UMTS Terrestrial Radio Access Network (UTRAN) is essentially a radio access network using wideband code division multiple access for wireless devices. High Speed Packet Access (HSPA) is an amalgamation of two mobile telephony protocols, High Speed Downlink Packet Access (HSDPA) and High Speed Uplink Packet Access (HSUPA), defined by 3GPP, that extends and improves the performance of existing 3rd generation mobile telecommunication networks utilizing the WCDMA. Such networks may be named WCDMA/HSPA.

The 3GPP has undertaken to evolve further the UTRAN and GSM based radio access network technologies, for example into evolved UTRAN (E-UTRAN) used in LTE.

The expression downlink (DL) is used for the transmission path from the base station to the wireless device. The expression uplink (UL) is used for the transmission path in the opposite direction i.e. from the wireless device to the base station.

A heterogeneous network (hetnet) is a network with more than one cell type and/or base station type. The difference between the different cell and/or base station types may relate to several different features, but most often there is a difference between the maximum transmit power (i.e. the power amplifiers differ) which also relates to the cell size. A typical hetnet scenario comprises a higher power cell and a lower power cell, which may be referred to as macro cell and pico cell respectively, where the macro cell is typically served by a base station transmitting with higher power than a base station serving the pico cell. A base station or node serving a macro, or higher power, cell, may be named a macro node and may correspond to a conventional base station. A base station or node serving a pico, or lower power cell, may be named a low power node (LPN) and thus a cell provided by such node may be named LPN cell. A LPN may correspond, for example, to a remote radio unit (RRU), pico, or micro base station, allowing expanding the network capacity in a cost-efficient way. Deployment of LPNs is seen as a powerful tool to meet the ever-increasing demand for mobile broadband services.

Deployed LPNs in a heterogeneous network are typically classified as either co-channel, where each LPN has its own cell identity, e.g. scrambling code, or combined cell where pico cells of the LPNs have the same cell identities as a macro cell that the pico cells typically are located within.

The purpose of LPNs and cells provided by such nodes, i.e. LPN cells, such as pico cells, is often to offload macro cells and increase the capacity per area unit. Two examples of use-cases for heterogeneous network deployment that may be envisioned are coverage holes and capacity enhancement for localized traffic hotspots. The downlink power associated with a macro cell is typically much higher than from a LPN cell (e.g. 20 W to 2 W) and the macro cell will cover a larger area in the downlink compared to the LPN cell. When a downlink connection is equally good from the macro cell and the LPN cell, an LPN uplink connection may be much better, e.g. 20/2=10 times better in case of the example of a 20 W vs. 2 W power difference. In heterogeneous networks there are thus typically locations where a wireless device has the best downlink connection to a macro cell e.g. owing to transmission with higher power in the downlink compared to a LPN cell, but at the same time a better uplink connection to the LPN cell, e.g. due to that the wireless device transmits with same power to both the macro and LPN cell but may be located closer to the LPN cell. This leads to imbalance and there being imbalance zones, or imbalance regions, where a first cell of a first type, e.g. a macro cell, provides the best downlink quality at the same time as a second cell of a second type, e.g. a LPN cell, provides the best uplink quality.

There are certain problems relating to hetnets and imbalance regions of hetnets in particular. For example, UL performance of a wireless device may be negatively affected in a hetnet, such as when the wireless is located in an imbalance region. Consider e.g. a wireless device that is served say in the outskirts of a macro cell and close to a border of a LPN cell. Such wireless device may transmit with relatively high power in the uplink to the macro cell and thereby cause relatively high interference to the closer LPN cell. This has negative impact on the uplink performance in the LPN cell, which e.g. may be identified by studying measurement graphs from interference measurements of neighbouring cells.

### SUMMARY

An object is to provide improvements in heterogeneous wireless communication networks, in particular improvements relating to uplink performance.

According to a first aspect of embodiments herein, the object is achieved by a method, performed by a network node, for managing uplink resources to be used by a wireless device. The network node being comprised in a wireless communication network comprising cells for serving the wireless device. Said cells forming at least one imbalance region in which the wireless device has the best quality in the downlink to a first cell of a first type and in the uplink to a second cell of a different, second type. The network node identifies a situation associated with a risk for undesired decrease of transmit power used by the wireless device when the wireless device moves in the imbalance region. The network node provides, in response to the identification, an adjustment and/or record of a load in the uplink between the wireless device and the first cell. The load being associated with a reference channel and used for determining one or more uplink resources to be used by the wireless device. The network node then provided use of said adjusted and/or recorded load for determining one or more uplink resources to be used by the wireless device.

According to a second aspect of embodiments herein, the object is achieved by a computer program comprising instructions that when executed by a processing circuit causes the network node to perform the method according to the first aspect.

According to a third aspect of embodiments herein, the object is achieved by a data carrier comprising the computer program according to the third aspect.

According to a fourth aspect of embodiments herein, the object is achieved by a network node for managing uplink resources to be used by a wireless device in a wireless communication network comprising cells for serving the wireless device. Said cells forming at least one imbalance region in which the wireless device has the best quality in the downlink to a first cell of a first type and in the uplink to a second cell of a different, second type. The network node is configured to identify a situation associated with a risk for undesired decrease of transmit power used by the wireless device when the wireless device (120) moves in the imbalance region. Further, the network node is configured to provide, in response to the identification, an adjustment and/or record of a load in the uplink between the wireless device and the first cell. The load being associated with a reference channel and used for determining one or more uplink resources to be used by the wireless device. Moreover, the network node is configured to provide use of said adjusted and/or recorded load for determining one or more uplink resources to be used by the wireless device.

The imbalance region described above is characteristic for what commonly is named a heterogeneous network, or hetnet, and the wireless communication network thus correspond to a hetnet. It has been identified that UL performance in hetnets, such as in the wireless communication network described above, and in particular in the case of UMTS and WCDMA/HSPA, is negatively affected by undesired, in particular large and quick, decreases in transmit power of wireless devices. The decreases being prone to occur for wireless devices in imbalance regions. The undesired decreases may e.g. lead to insufficient use of load resources, as filtered load measurements conventionally used cannot capture large and quick changes. As a result, performance in the hetnet, in particular in the UL, is degraded. By, as in embodiments herein, identifying a situation with risk for such decreases and in response to the identification provide the adjustment and/or record of the load which then is used for determining one or more uplink resources to be used by the wireless device, the load that else, e.g. conventionally, would be used, is avoided. Also, embodiments herein enable to provide the recorded and/or adjusted load sufficiently in advance to be able efficiently replace the load that else would be used. As a result, embodiments herein enable to alleviate or even avoid degradation in UL performance that else would occur.

### BRIEF DESCRIPTION OF THE DRAWINGS

Examples of embodiments herein are described in more detail with reference to the appended schematic drawings, which are briefly described in the following.

FIG. 1 is a block diagram schematically depicting an example of a wireless communication network in which embodiments herein may be implemented.

FIG. 2 schematically illustrates how a soft handover region and an imbalance region may relate to each other.

FIG. 3 is a combined signaling diagram and flowchart for describing embodiments herein.

FIG. 4 is a flow chart schematically illustrating a specific example of how actions according to embodiments herein may be carried out.

FIG. 5 is a flowchart schematically illustrating embodiments of a method performed in a network node.

FIG. 6 is a functional block diagram for illustrating embodiments of the network node.

FIGS. 7a-c are schematic drawings illustrating embodiments relating to a computer program product and computer program to cause the network node to perform method actions.

### DETAILED DESCRIPTION

Some details in the following description are in a UMTS and WCDMA/HSPA context and/or have a specific meaning in such context, as will be recognized by the skilled person. However, embodiments herein are not limited to only such context.

As a development towards embodiment herein, the problem indicated in the Background will first be further discussed and some existing terminology and solutions will be briefly mentioned and explained. Said terminology and solutions are such that are referred to in the discussion about the problem and in the description of embodiments herein that follows thereafter.

It has been identified that UL performance in hetnets, in particular in the case of UMTS and WCDMA/HSPA, e.g. is negatively affected by undesired, in particular large and quick, changes in transmit power of wireless devices, which changes are prone to occur for wireless devices in imbalance regions.

For example, for a wireless device in an imbalance region, served only by a macro cell and not in soft handover (SHO) with any cells of LPN(s), strong UL interference may be generated towards adjacent cells of LPN(s) when the LPN(s) cannot decrease data rate of the wireless device via relative grant. SHO is shortly explained separately below.

Said undesired power changes are thus likely to happen in imbalance regions and are more likely the stronger the imbalance. Undesired changes in the form of decreases may in particular occur when a wireless device in an imbalance region has a LPN added to an active set (AS) as used for SHO, which AS contains no LPN, or switches serving cell from a macro cell to an LPN cell and when an Inner Loop Power Control (ILPC) restriction is adopted when the wireless device is served in the macro cell. ILPC and ILPC restriction are explained separately below.

For instance, in case of normal ILPC (i.e. no ILPC restriction) there may be large and quick transmit power decrease of a wireless device when a LPN is added to the AS and there is not already any LPN cell in the AS, due to consecutive TPC “down” from the LPN added to the AS. In case of ILPC restriction, which typically is applied when the wireless device is in SHO with a serving macro cell and at least one non-serving LPN cell, there may be large and quick transmit power decrease of the wireless device when the wireless device is originally served in the serving macro cell and switches serving cell to the LPN cell, due to consecutive TPC “down” from the serving LPN cell.

The undesired power decreases, especially when large and quick, may lead to insufficient use of load resource, as filtered load measurements typically used for UL scheduling cannot capture such decreases, thereby negatively affecting UL performance. The situation is more severe at cell switch with ILPC restriction since the cell switch occurs where the UL is more imbalanced than when the LPN is added to the AS.

The object of embodiments herein, i.e. to improve performance in heterogeneous wireless communication networks, may thus more specifically be with regard to improving UL performance in the above discussed situations.

The concept of so called soft handover (SHO) mentioned above will now be briefly explained. SHO involves establishing some connection in advance between a wireless device and a cell for facilitating an actual handover if/when a handover decision is taken. For example in order to be able to carry out a faster and/or more reliable/seamless handover than otherwise would be the case. For implementation of soft handover, the soft handover may be explicitly or implicitly associated with a region for soft handover. The region for soft handover typically corresponds to a region, or range, of differences in downlink measurements performed by the wireless device on the best cell, typically but not necessarily being a serving cell, and another cell. Within said region or range it is desirable that the wireless device becomes and/or remains at least partly connected to the other cell, for example to facilitate a possible actual handover, i.e. change of the wireless device from being served in the serving cell to instead being served in said other cell. The downlink measurements on the cells are performed on signals, typically reference signals transmitted by respective base station serving the involved cells.

In WCDMA/HSPA, downlink measurements for handover purpose are typically quality measurements on e.g. a Common Pilot Channel (CPICH) of the base station serving the cell that is subject to the downlink measurements.

In addition to the actually best cell according to downlink measurements, a wireless device may add a connection to one or more other cells if their respective downlink measurement is within a certain offset from a downlink measurement on the best cell, e.g. the serving cell. The other cells may be non-serving cells. A so-called active set (AS), or AS list, associated with the wireless device, lists and/or comprises all cells to which the wireless device is connected to, or is at least partly connected to if e.g. fully connected is when the wireless device is connected and actually served in a cell. At least partly connected to a cell may thus refer to that there is some connection established between the wireless device and the cell, which connection is part of and/or facilitate a later actual handover to the cell. This is utilized in soft handover by adding a potentially new serving cell to the active set in advance as a non-serving cell. In WCDMA/HSPA it would typically be the RNC that finally decides if a wireless device shall add a new cell or not to the active set, which typically is accomplished by so called active set update Radio Resource Control (RRC) signalling between the wireless device and the RNC. It is also the RNC 130 that decides if an actual handover shall be carried out.

ILPC as mentioned above will now be briefly discussed and explained. ILPC for WCDMA/HSPA is e.g. disclosed in TS 25.214, v.10.0.0, section 5.1.2.2. The uplink ILPC adjusts transmit power of a wireless device in order to keep the received uplink SIR at a given SIR target that may be named SIR_target. Upon reception of one or more Transmit Power Control (TPC) commands in a TPC command combining period, the wireless device shall derive a single TPC command that may be named TPC_cmd, for each TPC command combining period in which a TPC command is known to be present, i.e. DPCCH is being transmitted.

There are two algorithms, Alg1 and Alg2, for deriving the TPC_cmd:

Alg1—According to this algorithm the wireless device derives TPC_cmd in each slot, which can take a value of either 1 (increase) or −1 (decrease).

Alg2—According to this algorithm the wireless device processes the received TPC commands on a 5-slot cycle, and derives one TPC_cmd every such 5-slot cycle. When not in SHO, TPC_cmd equals “1” or “−1” if all 5 hard decisions within a set are “1” or “−1”, otherwise it equals “0” (hold). During SHO, first one temporary TPC (TPC_temp) is derived for each radio link set as in a non-SHO case, then the UE derives a combined TPC_cmd. It equals “−1” if any of TPC_temp, equals “-1”, and it equals “1” if

$$\frac{1}{N} {\sum }_{i = 1}^{N} {TPC\_temp}_{i} > 0.5 ,$$

otherwise TPC_cmd is set to “0”.

Alg2 makes it possible to emulate smaller step sizes.

ILPC restriction as mentioned above will now be briefly discussed and explained. ILPC restriction for WCDMA/HSPA is e.g. disclosed in R1-142414, “On Control Channel Robustness for Secondary Pilot and ILPC Restriction Schemes”, which is a 3GPP contribution. According to ILPC restriction the DPCCH is solely power controlled by the serving cell and the uplink data channel such as Dedicated Physical Data Channel (DPDCH) and enhanced DPDCH (E-DPDCH) are set relative DPCCH, see e.g. TS25.214, release 12, v. 12.0.0, section 5.1.2. Power control according to ILPC restriction is achieved by either having the non-serving cells always issue TPC UP commands, i.e. increase power command, or having the wireless device ignore TPC commands from non-serving cells via a High Speed Shared Control CHannel (HS-SCCH) order. Letting the serving cell control the DPCCH implies that the DPCCH SIR in the non-serving cells will increase significantly. To make use of the increased DPCCH SIR in the non-serving cells, the reference value setting can be set more aggressively.

ILPC restriction may e.g. be adopted when a wireless device is in SHO with cells including a serving macro cell and at least one non-serving LPN cell. It can guarantee UL control robustness towards the serving macro cell. The ILPC restriction scheme also works for legacy wireless devices, i.e. wireless devices supporting release 11 and earlier of the 3GPP standard, see e.g. TS 25.214, release 11, version 11.0.0, section 5.1.2, if it is implemented by sending TPC UP commands from LPN(s).

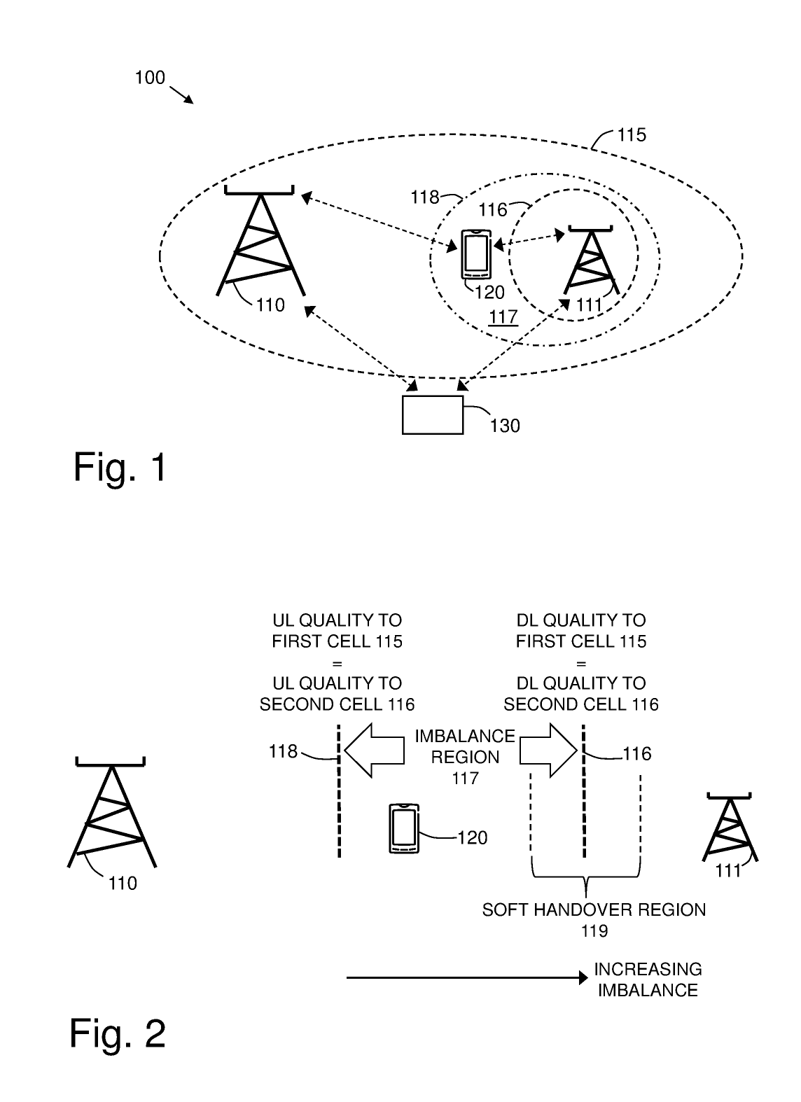

FIG. 1 depicts an example of a wireless communication network 100, e.g. a telecommunication network, in which embodiments herein may be implemented. The wireless communication network 100 may be a WCDMA/HSPA network but may be e.g. be any any cellular network or system, such as a, or based on a, UMTS, WCDMA, WCDMA/HSPA, LTE or GSM network, or any 3GPP cellular network.

The wireless communication network 100 comprises cells, e.g. a first cell 115 and a second cell 116, for serving one or more wireless devices, e.g. a wireless device 120 as shown in the figure. As should be recognized, the wireless device 120 is a device capable to wirelessly communicate in the wireless communication network 100 over one or more radio links, via network nodes of the wireless communication network 100, and with e.g. other communication devices in the same and/or other communication networks. The wireless device 120 may e.g. correspond to a user equipment, a mobile station, a mobile terminal or a wireless terminal, a mobile phone, a computer such as e.g. a laptop, a Personal Digital Assistants (PDAs) or a tablet computer, sometimes referred to as a surf plate, with wireless capability, a so called Machine to Machine (M2M) device or Machine Type of Communication (MTC) device, i.e. devices that are not associated with a conventional user, or any other radio network unit capable to wirelessly communicate over a radio link in the wireless communication network 100.

The first cell 115, or at least radio coverage thereof, may be provided by a first network node 110 comprised in the wireless communication network 100 and is typically a radio network node comprised in a Radio Access Network (RAN) part of the wireless communication network 100. More specifically the first network node 110 is typically, as illustrated in the figure, an RBS, for example an NodeB, NB, eNodeB, eNB or any other network node capable of serving a wireless device, such as the wireless device 120, in the wireless communication network 100.

The second cell 116, or at least radio coverage thereof, may be provided by a second network node 111 comprised in the wireless communication network 100 and is typically a radio network node comprised in the RAN. More specifically the second network node 111 is typically, as illustrated in the figure, an RBS, for example an NodeB, NB, eNodeB, eNB or any other network node capable of serving a wireless device, such as the wireless device 120, in the wireless communication network 100.

Note that typically the first network node 110 and the second network node 111 are different nodes and/or units, logically and/or physically, but that they may be one and the same logical and/or physical node and/or unit, and that thus the first cell 115 and the second cell 116 may be provided by one and the same physical and/or logical network node and/or unit. For example, there may be one base station that provides both the first cell 115 and the second cell 116.

The first network node 110 and/or the second network node 111 may be controlled by a third network node 130 comprised in the wireless communication network 100. The third network node is typically also a radio network node comprised in the RAN. More specifically the third network node 130 is typically a controlling node, e.g. a RNC.

The first cell 115 is of a first type and the second cell is of a different, second type. The second type may be associated with substantially lower downlink power than the first types. The first type may be a conventional type of cell served with conventional transmit power, e.g. 20 W, by a base station. That is, the first network node 110 may serve the first cell using transmit power that may be considered conventional and the first network node 110 may be a conventional base station. A cell of the first type, e.g. the first cell 115, may be named a macro cell.

The second type may be a low, or lower, power type of cell that served with lower transit power than the first type and thus may be lower transmit power than conventionally, e.g. 2 W. That is, the second cell 116 may be served with lower transmit power than the first cell. Cells of the second type may be named pico cells or LPN cells.

The wireless communication network 100 may be named an heterogeneous wireless communication networks, or hetnet, which may be classified either as co-channel or combined cell.

The first cell 115 and the second cell 116 form, or cause, an imbalance region 117 in which the wireless device 120 has the best quality in the downlink to the first cell 115 and in the uplink to the second cell 116. The imbalance region 117 may be caused by the above described difference in transmit power for serving the first cell 115 and the second cell 117, but other reasons are also possible. For example, the first network node 110 providing the first cell 115 may comprise an improved, e.g. more advanced, UL receiver while the second network node 111 providing the second cell 116 may comprise a conventional UL receiver, which results in that the wireless device 120 may have better quality in the UL to the first cell 115 owing to the advanced UL receiver while the wireless device may have better quality in DL to the second cell.

The numbered dotted perimeters representing each cell in FIG. 1 indicate a respective DL coverage area where the cell in question provides the best downlink quality, i.e. if the wireless device 120 would be located within the perimeter of the DL coverage area of the second cell 116, the second cell 116 would provide the best quality for the downlink. If the wireless device 120 is located outside the perimeter of the DL coverage area of the second cell 116 but still within the perimeter of the DL coverage area of the first cell 115, as exemplified in the figure, the first cell 115 provides the best quality for the downlink. To be able to illustrate the imbalance zone 117 and the difference in downlink and uplink quality, the figure has been furnished also with a perimeter of an uplink coverage area 118 associated with the second cell 116. When the wireless device 120 is located within the perimeter of the uplink coverage area 118, as shown in the figure, the second cell 116 provides the best quality for the uplink and if outside the first cell 115 provides the best quality for the uplink. The imbalance region 117 exemplified in the figure is thus between the perimeter of the cell area of the second cell 116 and the perimeter of the uplink coverage area 118.

Note that how the first cell 115 and the second cell 116 in FIG. 1 have been drawn in relation to each other, where e.g. the second cell 116 is located within the first cell 110, is just an example. The first cell 115 and the second cell 116 may alternatively e.g. have partly overlapping cell areas and it may even be so that the cell areas defined by downlink quality does not overlap at all but e.g. the uplink coverage area 118 of the second cell 116 partly overlap the cell area of the first cell 115.

Attention is drawn to that FIG. 1 is only schematic and for exemplifying purpose and that not everything shown in the figure is required for all embodiments herein, as will be evident to the skilled person based on what is disclosed herein. Also, a wireless communication network that in reality corresponds to the wireless communication network 100 typically comprises several further network nodes, base stations, cells etc., as realized by the skilled person, but which are not shown herein for the sake of simplifying.

FIG. 2 schematically illustrates how a soft handover (SHO) region as mentioned above, here exemplified as an SHO region 119, and the imbalance region 117 may relate to each other. Note that the SHO region 119 is just an example. The SHO region 119 and imbalance region 117 may exist independent of each other. In general a SHO region associated with a cell may be determined by one or more parameter settings and/or algorithms in the wireless device 120 and/or one or more network nodes associated with the cell, e.g. the SHO region 119 may be determined by parameter settings and/or algorithms in the wireless device 120 and/or in the first network node 111 and/or third network node 130. Note that a SHO region in general need not be centered around the equal DL quality line as shown in the figure. The equal DL quality line e.g. corresponding to the numbered dotted perimeter of the second cell 116 where the second cell 116 and the first cell 115 provide substantially equal downlink quality. However, in general, a SHO region typically at least comprises the equal DL quality line and thus more or less overlap with an imbalance region when such exists between cells. It is realized that the imbalance in an imbalance region, e.g. as illustrated in the figure for the imbalance region 117, is increasing when approaching the equal DL quality line.

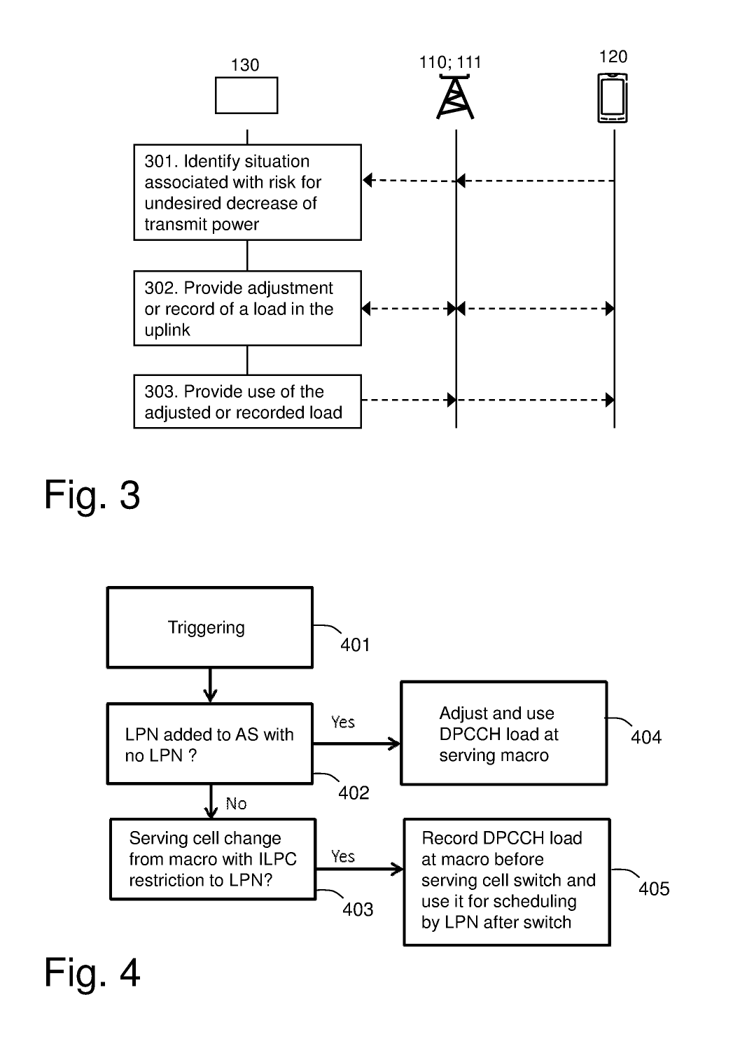

FIG. 3 depicts a combined signaling diagram and flowchart and will be used to discuss examples of embodiments herein relating to a method performed by the third network node 130. Particularly, the examples will relate to UMTS and WCDMA/HSPA where the third network node 130 is a RNC. However, as should be realized by the skilled person, in case the wireless communication network is based on another radio access technology (RAT) where e.g. corresponding functionality as in the RNC is in the base stations, such as in the case of LTE, most if what is described below may instead be performed by another network node or nodes, e.g. the first network node 110 and/or the second network node 111, which in the case of LTE would be eNBs.

The method comprises the following actions, which actions may be taken in any suitable order and/or be carried out fully or partly overlapping in time when this is possible and suitable.

Action 301

The third network node 130 identifies a situation associated with a risk for undesired decrease of transmit power used by the wireless device 120 when the wireless device 120 moves in the imbalance region 117. The identified situation in the present action is used to trigger actions 302-303 below, which relates to making use of another load than else would be the case for determining one or more uplink resources to be used by the wireless device 120.

As should be realized and as illustrated in the figure, the third network node 130, such as in case of a RNC, may base the identification on information received from the first network node 110, the second network node 111 and/or from the wireless device 120. For example, in the case of the third network node 130 being a RNC, the identification is typically based on information from the first network node 110 being a NodeB corresponding to a macro base station and/or from the second network node 111 typically being another NodeB and corresponding to a LPN. The information from the first network node 110 and/or the second network node is in this case in turn based on information from the wireless device 120, e.g. information resulting from measurements performed by the wireless device 120.

In some embodiments, the identified situation comprises a first situation where the second cell 116 of the second type, e.g. a LPN cell, is added to an AS of the wireless device 120, which AS comprises no cells of the second type. Expressed differently, the identified situation may correspond to, or indicate, that the second cell 116 of the second type is added to the AS of the wireless device 120, which AS at that point contains no cell of the second type. In the case of e.g. UMTS and WCDMA/HSPA, the third network node 130 being a RNC may obtain this information internally since AS updates are performed by the RNC.

In some embodiments, the identified situation instead comprises a second situation where the wireless device 120 switches serving cell from the first cell 115, e.g. being a macro cell, where the wireless device 120 applies ILPC restriction, to the second cell 116, e.g. being a LPN cell.

In the case of UMTS and WCDMA/HSPA and the third network node 130 being a RNC, the RNC is involved in cell switch decisions and updating the AS, and thus has direct access to information for identifying the situation, e.g. according to any of the above described embodiments.

The first and/or second situations described above may each or in combination, when applicable, be considered as an indicator of said risk for undesired decrease of transmit power, and identification thereof may thus trigger the next action.

Action 302

The third network node 130 provides, in response to the identification in Action 301 above, an adjustment or record of a load in the uplink between the wireless device 120 and the serving first cell 115, which load is associated with a reference channel and used for determining one or more uplink resources to be used by the wireless device 120.

The determination of the one or more uplink resources are typically performed in the context of scheduling of resources to the wireless device 120 and is typically performed by a so called scheduler, or scheduler functionality, which in case of UMTS is comprised in the RNC and thus may be comprised in the third network node 130, or in case of UMTS and WCDMA/HSPA is comprised in the base stations and thus may be comprised in the first network node 110 and the second network node 111.

The load is typically a filtered load which is used to make operation more stable when the load is used. The filtering is typically a low pass filtering. The reference channel may be such that other channels have their transmit power set in relation to, so that a change in load of the reference channel will thus have impact on the other channels.

For example, in the case of UMTS and WCDMA/HSPA, the reference channel is preferably the DPCCH and the load is preferably filtered load of the DPCCH.

The load may be adjusted based on a measure of an imbalance between the serving first cell 115 and the second cell 116, which imbalance is experienced by the wireless device 120. This enables the imbalance to be taken into account when the one or more uplink resources are determined and e.g. scheduled. The adjustment of the load may be provided in response to that the second cell 116, as discussed above under Action 301, is actually added to the AS. A more specific and detailed example regarding load adjustment can be found below in an “adjusted load” example.

The recording of the load should be accomplished before the actual switch, i.e. before the wireless device 120 switches serving cell from the first cell 115, e.g. being a macro cell, to the second cell 116, e.g. being a LPN cell. A more specific and detailed example regarding recorded load can be found below in a “recorded load” example.

As should be realized and as illustrated in the figure, the third network node 130, such as in case of a RNC, may accomplish the provision of the adjustment and/or record of the load fully or partly internally, i.e. the third network node may itself adjust and/or record said load, e.g. using information it already has access to. However, depending on RAT and functionality of the third network node 130, the provision may involve also one or more further nodes. For example, the third network node 120 may command one or more further nodes, e.g. the first network node 110 and/or the second network node 111, to carry out or participate in the adjustment and/or record of the load, e.g. command them to adjust or record the load or provide information to be used by the third network node 130 for carrying out the adjustment and/or record of the load.

Action 303

The third network node 130 provides use of said adjusted and/or recorded load for determining one or more uplink resources to be used by the wireless device 120. In other words, after the adjustment and/or record of the load in the foregoing action, the present action is about making sure that the adjusted and/or recorded load then is used, e.g. by a scheduler, for determining one or more uplink resources to be used by the wireless device 120. That is, so that the adjusted and/or record load are used instead of the load that else, such as conventionally, would be used.

The adjusted and/or recorded load may be used by the third network node 130 itself to determine said one or more uplink resources, e.g. when the third network node 130 is a RNC comprising a scheduler as may be the case in UMTS. Or, in the case of WCDMA/HSPA or LTE, with scheduling taking part in the base stations, the adjusted load may be provided for use in the first cell 115 by the first network node 110 when the second cell 116 is added to the AS. The recorded load may be provided for use in the second cell 116 by the second network node 111 when the second cell 116 become the serving cell.

Hence, for example, the present action may be performed by commanding another node, e.g. first network node 110 and/or the second network node 111, to use the adjusted and/or recorded load for determining the one or more uplink resources to be used by the wireless device 120.

Hence, depending on RAT and functionality of the third network node 130, the provision according to the present action may involve one or more further network nodes. For example, the third network node 130 may command one or more further network nodes, e.g. such comprising scheduling functionality, so said one or more further network nodes will be using the adjusted and/or recorded load for determining said one or more uplink resources to be used by the wireless device 120.

An example of how the adjusted and/or recorded load may be used by the third network node 130 to determine said one or more uplink resources is in a load headroom to power offset mapping. Load head room to power offset mapping is separately described below.

For example, the recorded load may be used in the load headroom to power offset mapping in response to the actual switch as mentioned above under Action 302, i.e. when, such as directly after, the wireless device 120 has switched serving cell from the first cell 115, e.g. being a macro cell, to the second cell 116, e.g. being a LPN cell.

The recorded load may be used until a difference between a current load in the uplink between the wireless device 120 and the serving second cell 115 and the recorded load equals or is below a threshold value. This is exemplified in some further detail below in the “recorded load” example.

The adjusted load and/or recorded load may be used at least until the second cell 116 stops sending consecutive transmit power control (TPC) commands to the wireless device 120, which consecutive commands consecutively commands the wireless device 120 to decrease power. This is exemplified in some further detail below in the “adjusted load” and “recorded load” examples.

In any case, the present action should result in that one or more uplink resources to be used by the wireless device 120 are determined. Actions that may follow after this may be conventional and typically involves that information is provided to the wireless device 120 about said uplink resources to be used, and that the wireless device 120 then use the uplink resources for transmitting in the uplink.

As mentioned above, the undesired power decreases, especially when large and quick, may lead to insufficient use of load resource, as filtered load measurements conventionally used for UL scheduling cannot capture such decreases. As a result, uplink performance is degraded and thus negatively affected. By, as in embodiments herein, identifying a situation with risk for such decreases and in response to the identification provide the adjustment and/or record of the load which then is used for determining one or more uplink resources to be used by the wireless device, the load that else, e.g. conventionally, would be used, is avoided. Also, embodiments herein enable to provide the recorded and/or adjusted load sufficiently in advance so that the load that else would be used can be efficiently replaced.

As a result embodiments herein enable to alleviate or even avoid degradation in UL performance that else would occur, and thereby improve uplink performance.

A further advantage is that embodiments herein may be implemented in a way transparent to the wireless devices, i.e. may be implemented without the need of update already existing, so called legacy, wireless devices, although the problem is degradation of UL performance which is associated with transmission by the wireless devices.

An detailed example of “adjusted load” in a UMTS context will now follow regarding how load may be adjusted and then used. The following may be triggered by that the second cell 116, in this example a LPN cell, is added to the AS as described above under Action 301 and may be carried out by the third network node 130 being a RNC. A filtered DPCCH load, which may be named load_macro, is adjusted for the serving first cell 115, in this example a macro cell, while considering the imbalance between the serving first cell 115 and the second cell 116 to be added to the AS. The adjusted load, which may be named adjustedLoad_macro, may be calculated based on the following equation:

adjustedLoad_macro=load_macro*(RSRP_{macro}*CIO_{macro})/(RSRP_{LPN}*CIO_{LPN})*k (Eq. 1),

where k is a regulation parameter between 0 and 1, RSRP is Reference Signal Received Power and CIO is Cell Individual Offset. Both RSRP and CIO are known and defined in the context of UMTS. In the example, the index “macro” thus refers to the first cell 115 and the index “LPN” thus refers to the second cell 116.

When SHO is triggered, the right hand part of the equation except for k, corresponds to the difference in average DL quality between the first cell 115, i.e. in this example the macro cell, and the wireless device 120, and between the second cell 116, i.e. in this example the LPN cell, and the wireless device 120. This is also the average difference in UL received power at the first network node 110, here the macro node, and the second network node 111, here the LPN node, when the second cell 116 being a LPN cell is added to the AS, such as when the first situation as described above under Action 301 occurs and is identified.

Hence, transmit power of the wireless device 120 will roughly decrease by an amount corresponding to said difference so that the UL perceived quality at the best UL node will roughly remain the same. The equation takes this decrease into account in advance and estimates the load that would result after the power decrease, and thus mitigates the impact of delay in load estimation. The regulation parameter k is to avoid overcompensation as the adjustment is based on average measure. Typical settings of k may be at or in the range 0.7-0.8.

Calculating the adjustedLoad_macro as described above is thus an example of Action 302.

The adjustedLoad_macro may then, when the second cell 116 being a LPN is actually added to the AS, be used by the third network node 130 in load headroom to power offset, or data rate, mapping. This is an example of Action 303.

The adjustedLoad_macro may be used at least until the second network node 111 stops sending consecutive TPC “−1”, i.e. TPC down, for decreasing power or that a ratio of TPC “−1” out of a certain number, e.g. K, TPCs or during a certain time period is smaller than a certain threshold value that may be predetermined. The threshold value may correspond to the threshold named thr_tpc below. The threshold value may be selected to ensure that an ongoing power decrease has slowed down sufficiently. This does not likely cause overscheduling as ILPC is much faster than scheduling and the instantaneous DPCCH load at the serving first network node 110, here macro, should already be decreased when a scheduling grant is utilized by the wireless device 120.

An detailed example of “recorded load” in a UMTS context will now follow regarding how load may be recorded and then used. The following may be triggered by that the wireless device 120 switches serving cell from the first cell 115 to the second cell 116 as described above under Action 301 and may be carried out by the third network node 130 being a RNC.

A filtered DPCCH load, which may be named load_macro, is recorded at the best cell of the first type, in this example a macro cell, e.g. the first cell 115. This is an example of action 302. Then, when the second cell 116, in this example a LPN cell, actually has become the serving cell, the recorded load_macro is used in the second cell 116 in load headroom to power offset, or data rate, mapping. This is an example of Action 303.

The recorded load_macro may be used in the second cell 116 until a difference between the filtered DPCCH load at the second cell 116, here the LPC cell, and the recorded load_macro is smaller than a threshold, that may be named thr_load. The threshold may be predefined and/or predetermined, e.g. by an operator of the wireless communication network 100. A typical setting of a value for thr_load is in the range of 0.1 to 0.2. Hence, the actual load, i.e. that of the second cell 116 which may be named load_LPN, is used instead of the recorded load if the relative difference between load_LPN and the recorded load_macro is smaller than thr_load.

Alternatively or additionally, the recorded load_macro may be used at least until the second network node 111, here the LPN node, stops sending consecutive TPC “−1”, i.e. TPC down, or that a ratio of TPC “−1” out of a certain number, e.g. K, TPCs or during a certain time period is smaller than a certain threshold value that may be predetermined and may be named thr_tpc. The threshold value may be selected to ensure that power decrease has slowed down sufficiently. This will likely not cause overscheduling as I LPC is much faster than scheduling and the instantaneous DPCCH load at the second network node 111 should already have become similar as load_macro when the scheduling grant is utilized by the wireless device 120. A typical setting of thr_tpc may be about 2/3. If the ratio of TPC “−1” out of K TPCs is more than 1/2 there will be a decrease of transmit power of the wireless device 120 and thus the higher the ratio, the larger the power decrease. Hence when the ratio is less than thr_tpc this indicates that problematic large and fast transmit power decreases are no longer likely to occur and load estimated in a conventional way can be used instead, such as an estimation of a present load at the second cell 116, i.e. the LPN cell in thus example.

Load headroom to power offset, or data rate, mapping as such is known from the prior art, see e.g. Harri Holma, Antti Toskala, “WCDMA for UMTS—radio access for third generation communications”, third edition, W/LEY. However, some general principles of load headroom to power mapping will be discussed in the following to facilitate understanding.

For the (W)CDMA uplink, the common radio resource shared among the wireless devices is the total amount of tolerable interference, which is defined as the average interference over all the antennae. Based on this tolerable interference it may be determined how much load resource is available for a cell, i.e. the load headroom. What typically is named load factor represents the portion of uplink interference that a certain channel of a certain wireless device generates, which is defined as the interference due to the channel of that wireless device divided by the total interference.

The High-Speed Uplink Packet Access (HSUPA) scheduler is responsible for controlling the transmission activity of wireless devices by assigning them scheduling grants which sets an upper limit on the data rate a user can transmit with. Implementation of this may involve determining a, e.g. maximum, supportable power offset between a data channel, e.g. an Enhanced Dedicated Physical Data CHannel (E-DPDCH) in HSUPA, to be scheduled and the DPCCH, where DPCCH is a fixed rate channel. Based on the above the following equation may be formed.

$${pwroff}_{data}^{supportable} = \frac{{power}_{data}^{max available}}{{power}_{DPCCH}} = \frac{{power}_{data}^{max available} / {interference}_{total}}{{power}_{DPCCH} / {interference}_{total}} = \frac{{loadheadroom}_{data}}{{loadfactor}_{DPCCH}} \qquad ( Eq . 2 )$$

A supportable data rate may thus be determined based on the supportable power offset and granted to the wireless device that is scheduled to transmit. The scheduling grant may be updated by sending either an absolute grant or a relative grant, carried by the Enhanced Relative Grant Channel (E-RGCH). Absolute grant is used for absolute changes of the scheduling grant. Relative grant is used for relative changes of the scheduling grant. Relative grant from a non-serving cell provides the possibility for the non-serving cell to control inter-cell interference. With fast inner loop power control (ILPC) the DPCCH power and the DPCCH load likely have quick and large variation especially if the interference level is high. As mentioned above, typically filtered load measurements are used to make operations more stable.

FIG. 4 is a flow chart schematically illustrating a specific example of how actions 301-303 above may be carried out. In an action 401 there is triggering to apply embodiments herein, e.g. by identification of the situation as discussed above under Action 301. Following the triggering it is in an action 402 checked if a LPN was added to the AS when there was no LPN in the AS. As discussed above, this is something that may have caused the triggering. If this was not the case, it is in an action 403 checked if there will be a serving cell change from a macro cell to a LPN cell with ILPC restriction applied in the macro cell. As discussed above, this is also something that may have caused the triggering.

If the check in action 402 was confirmative, it is in an action 404 being adjusted and used an filtered DPCCH load at the serving cell being a macro cell. For example, action 404 may be carried out as discussed above in the “adjusted load” example. As should be recognized, actions 401, 402 and 404 may thus correspond to Actions 301-303 in the case of “load adjustment”.

If the check in action 403 was confirmative, it is in an action 405, before the actual switch, being recorded an filtered DPCCH load when the serving cell is the macro cell, and the recorded load is used for scheduling in the LPN cell after the switch. For example, action 405 may be carried out as discussed above in the “recorded load” example. As should be recognized, actions 401, 403 and 405 may thus correspond to Actions 301-303 in the case of “load record”.

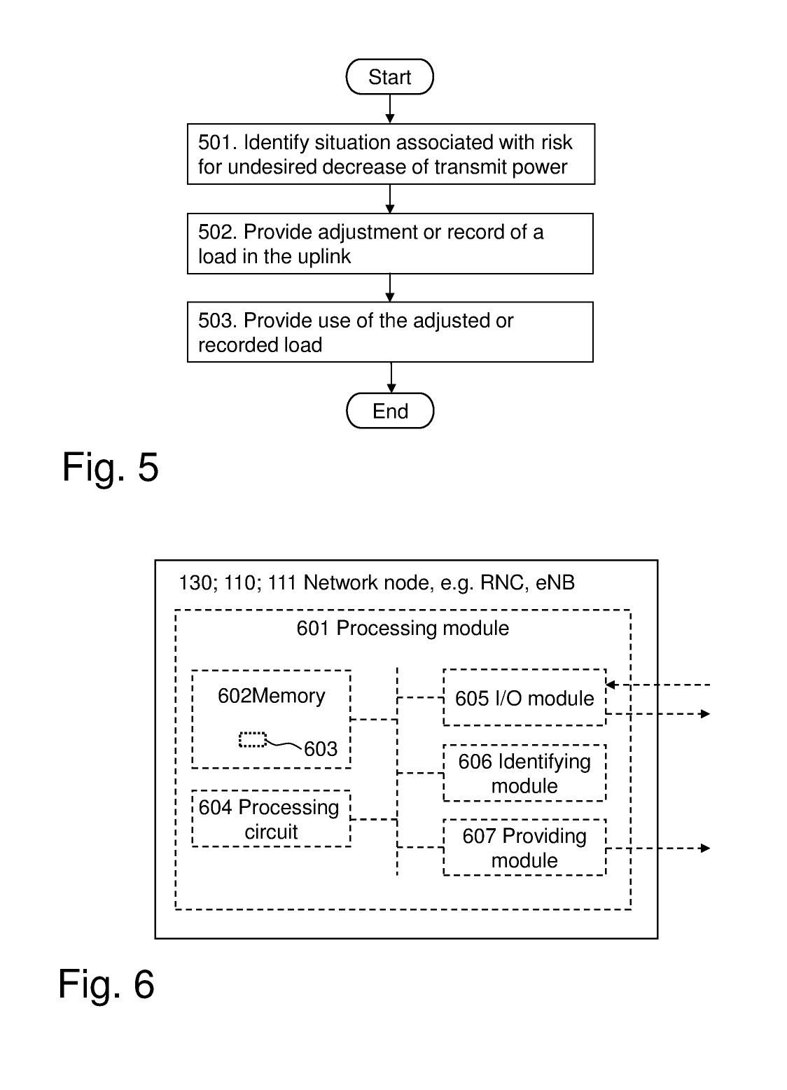

FIG. 5 is a flow chart schematically illustrating embodiments of a method, performed by a network node, e.g. any one of the first network node 110, the second network node 111 and the third network node 130, for managing uplink resources to be used by the wireless device 120. For the sake of simplifying reading, the third network node 130 will be used to exemplify the network node in the following. Hence, the third network node 130 may in the following be replaced by e.g. any one of the first network node 110 and the second network node 111. As mentioned above, the third network node 20 130 is comprised in the wireless communication network 100 comprising cells, such as the first cell 115 and the second cell 116, for serving the wireless device 120. Said cells form at least one imbalance region, such as the imbalance region 117, in which the wireless device 120 has the best quality in the downlink to the first cell 115 of the first type and in the uplink to the second cell 116 of the different, second type.

The method comprises the following actions, which actions may be taken in any suitable order and/or be carried out fully or partly overlapping in time when this is possible and suitable.

Action 501

The third network node 130 identifies a situation associated with a risk for undesired decrease of transmit power used by the wireless device 120 when the wireless device 120 moves in the imbalance region 117.

In some embodiments, the identified situation comprises that the second cell 116 of the second type is added to an active set list that comprises no cells of the second type. The active set list being a list associated with one or more cells that the wireless device 120 is at least partly connected to.

Further, in some embodiments, the identified situation comprises that the wireless device 120 switches serving cell from the first cell 115 to the second cell 116. The identification may be further based on that a restriction, such as ILPC restriction, is associated with the uplink power control when the wireless device 120 is served by the first cell 115. The restriction comprises that one or more uplink channels are solely controlled by the first cell 115 as serving cell. When the wireless device 120 is served by the first cell 115 it may at least partly be connected to one or more cells of the second type, such as the second cell 116.

This action may fully or partly correspond to action 301 discussed above.

Action 502

The third network node 130 provides, in response to the identification, an adjustment and/or record of a load in the uplink between the wireless device 120 and the first cell 115. The load being associated with a reference channel, such as filtered load of the DPCCH, and used for determining one or more uplink resources to be used by the wireless device 120.

In some embodiments, said adjustment of the load is provided in response to that the second cell 116 is actually added to the active set list.

In some embodiments, the load is adjusted based on a measure of an imbalance between the serving first cell 115 and the second cell 116, which imbalance is experienced by the wireless device 120. Equation Eq. 1 in the “adjusted load” example above is an example of this.

Moreover, in some embodiments, said record of the load in the first cell 115 is before the wireless device 120 switches serving cell to second cell 116.

This action may fully or partly correspond to action 302 discussed above.

Action 503

The third network node 130 provides use of said adjusted and/or recorded load for determining one or more uplink resources to be used by the wireless device 120.

In some embodiments, the provided use of the adjusted and/or recorded load comprises that the adjusted and/or recorded load is used in a load headroom to power offset mapping. The load headroom to power offset mapping being used for determining said one or more uplink resources to be used by the wireless device 120.

Further, in some embodiments, said use of the recorded load is provided in response to actual switching to the second cell 116.

Moreover, in some embodiments, said use of the recorded load is stopped in response to that a difference between a current load, in the uplink between the wireless device 120 and the second cell 115, and the recorded load equals or is below a threshold value. The threshold thr_load as discussed above is an example of this.

Furthermore, in some embodiments, said use of the adjusted load and/or recorded load is stopped in response to that the second cell 116 stops sending consecutive TPC commands to the wireless device 120, which consecutive commands consecutively commands the wireless device 120 to decrease power.

This action may fully or partly correspond to action 303 discussed above.

FIG. 6 is a schematic block diagram for illustrating embodiments of the network node mentioned above in connection with FIG. 5, for managing uplink resources to be used by the wireless device 120 in the wireless communication network 100, in particular how the network node may be configured to perform the method and actions discussed above in connection with FIG. 5. As mentioned above, the network node may e.g. be any one of the first network node 110, the second network node 111 and the third network node 130. Also here for the sake of simplifying reading, the third network node 130 will be used to exemplify the network node in the following text. Hence, the third network node 130 may in the following text e.g. be replaced by any one of the first network node 110 and the second network node 111.

The third network node 130 may comprise a processing module 601, such as a means, one or more hardware modules, including e.g. one or more processors, and/or one or more software modules for performing said methods and/or actions.

The third network node 130 may further comprise a memory 602 that may comprise, such as contain or store, a computer program 603. The computer program comprises ‘instructions’ or ‘code’ directly or indirectly executable by the third network node 130 so that it performs the said methods and/or actions. The memory 602 may comprise one or more memory units and may be further be arranged to store data, such as configurations and/or applications involved in or for performing functions and actions of embodiments herein.

Moreover, the third network node 130 may comprise a processing circuit 604 as an exemplifying hardware module and may comprise or correspond to one or more processors. In some embodiments, the processing module 601 may comprise, e.g. ‘is embodied in the form of’ or ‘realized by’ the processing circuit 604. In these embodiments, the memory 602 may comprise the computer program 603 executable by the processing circuit 604, whereby the third network node 130 is operative, or configured, to perform said method and/or actions.

Typically the third network node 130, e.g. the processing module 601, comprises an Input/Output (I/O) module 605, configured to be involved in, e.g. by performing, any communication to and/or from other units and/or nodes, such as sending and/or receiving information to and/or from other external nodes or devices. The I/O module 605 may be exemplified by an obtaining, e.g. receiving, module and/or a providing, e.g. sending, module, when applicable.

In further embodiments, the third network node 130, e.g. the processing module 601, may comprise one or more of an identifying module 606 and a providing module 607 as exemplifying hardware and/or software module(s). In some embodiments, the identifying module 606 and/or the providing module 607 may be fully or partly implemented by the processing circuit 604.

Therefore, according to the various embodiments described above, the third network node 130, and/or the processing module 601 and/or the identifying module 606 are operative, or configured, to identify said situation associated with a risk for undesired decrease of transmit power used by the wireless device 120 when the wireless device 120 moves in the imbalance region 117.

Moreover, according to the various embodiments described above, the third network node 130, and/or the processing module 601 and/or the providing module 607 are operative, or configured, to provide, in response to the identification, said adjustment and/or record of the load in the uplink between the wireless device 120 and the first cell 115.

Further, according to the various embodiments described above, the third network node 130, and/or the processing module 601 and/or the providing module 607 are operative, or configured, to provide said use of said adjusted and/or recorded load for determining one or more uplink resources to be used by the wireless device 120.

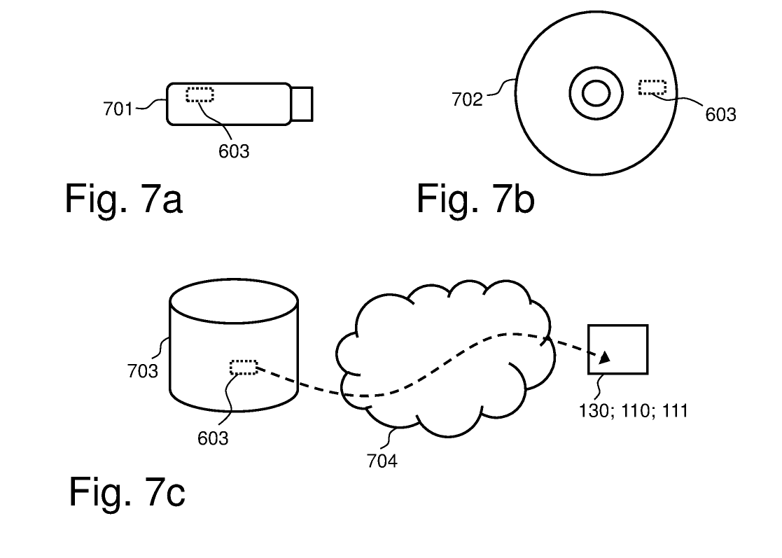

FIGS. 7a-c are schematic drawings illustrating embodiments relating to a computer program that may be the computer program 603 and that comprises instructions that when executed by the processing circuit 604 and/or the processing module 601, causes the first network node 110, the second network node 111 and/or the third network node 130 to perform as described above.

In some embodiments there is provided a data carrier, e.g. a computer program product, comprising the computer program 603. The data carrier may be one of an electronic signal, an optical signal, a radio signal, and a computer readable medium. The computer program 603 may thus be stored on the computer readable medium. By data carrier may be excluded a transitory, propagating signal and the data carrier may correspondingly be named non-transitory data carrier. Non-limiting examples of the data carrier being a computer-readable medium is a memory card or a memory stick 701 as in FIG. 7a, a disc storage medium 702 such as a CD or DVD as in FIG. 7b, a mass storage device 703 as in FIG. 7c. The mass storage device 703 is typically based on hard drive(s) or Solid State Drive(s) (SSD). The mass storage device 703 may be such that is used for storing data accessible over a computer network 705, e.g. the Internet or a Local Area Network (LAN).

The computer program 603 may furthermore be provided as a pure computer program or comprised in a file or files. The file or files may be stored on the computer-readable medium and e.g. available through download e.g. over the computer network 705, such as from the mass storage device 703 via a server. The server may e.g. be a web or File Transfer Protocol (FTP) server. The file or files may e.g. be executable files for direct or indirect download to and execution on the first network node 110, the second network node 111 and/or the third network node 130, e.g. by the processing circuit 604. They may also or alternatively be for intermediate download and compilation involving the same or another processor to make them executable before further download and execution causing the first network node 110, the second network node 111 and/or the third network node 130 to perform the method as described above.

Note that any processing module(s) mentioned in the foregoing may be implemented as a software and/or hardware module, e.g. in existing hardware and/or as an Application Specific integrated Circuit (ASIC), a Field-Programmable Gate Array (FPGA) or the like. Also note that any hardware module(s) and/or circuit(s) mentioned in the foregoing may e.g. be included in a single ASIC or FPGA, or be distributed among several separate hardware components, whether individually packaged or assembled into a System-on-a-Chip (SoC).

Those skilled in the art will also appreciate that the modules and circuitry discussed herein may refer to a combination of hardware modules, software modules, analog and digital circuits, and/or one or more processors configured with software and/or firmware, e.g. stored in memory, that, when executed by the one or more processors make the radio network node 110 and/or wireless device 121 to be configured to and/or to perform the above-described methods, respectively.

The term “network node” as used herein may as such refer to any type of radio network node (described below) or any network node, which may communicate with at least a radio network node. Examples of such network nodes include any radio network node stated above, a core network node (e.g. MSC, MME, etc.), Operations & Maintenance (O&M), Operations Support Systems (OSS), Self Organizing Network (SON) node, positioning node (e.g. E-SMLC), MDT etc.

The term “radio network node” may refer to any type of network node serving a wireless device, e.g. UE, and/or that are connected to other network node(s) or network element(s) or any radio node from which a wireless device receives signals. Examples of radio network nodes are Node B, base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

The term “node” as used herein may be used for the sake of simplicity, in order to denote a node which may be a network node, a radio network node or a wireless device, as applicable.

Note that although terminology used herein may be particularly associated with and/or exemplified by certain cellular communication systems, wireless communication networks etc., depending on terminology used, such as wireless communication networks based on 3GPP, this should not be seen as limiting the scope of the embodiments herein to only such certain systems, networks etc.

As used herein, the term “memory” may refer to a hard disk, a magnetic storage medium, a portable computer diskette or disc, flash memory, random access memory (RAM) or the like. Furthermore, the memory may be an internal register memory of a processor.

Also note that enumerating terminology such as first network node, second network node, first wireless device, second wireless device, etc., as such should be considering non-limiting and the terminology as such does not imply a certain hierarchical relation. Without any explicit information in the contrary, naming by enumeration should be considered merely a way of accomplishing different names.

As used herein, the expression “configured to” may mean that a processing circuit is configured to, or adapted to, by means of software or hardware configuration, perform one or more of the actions described herein.

As used herein, the terms “number”, “value” may be any kind of digit, such as binary, real, imaginary or rational number or the like. Moreover, “number”, “value” may be one or more characters, such as a letter or a string of letters. Also, “number”, “value” may be represented by a bit string.

As used herein, the expression “in some embodiments” has been used to indicate that the features of the embodiment described may be combined with any other embodiment disclosed herein.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of uni-casting, one specifically addressed device may receive and encode the transmission. In case of group-casting, e.g. multi-casting, a group of specifically addressed devices may receive and decode the transmission.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1-22. (canceled)

23. A method, performed by a network node, for managing uplink resources to be used by a wireless device, the network node being comprised in a wireless communication network comprising cells for serving the wireless device, the cells forming at least one imbalance region in which the wireless device has the best quality in the downlink to a first cell of a first type and in the uplink to a second cell of a different, second type, wherein the method comprises:
identifying a situation associated with a risk of an undesired decrease of transmit power used by the wireless device when the wireless device moves in the imbalance region;
providing, in response to the identification, at least one of adjustment and recording of a load in the uplink between the wireless device and the first cell, wherein the load is associated with a reference channel and used for determining one or more uplink resources to be used by the wireless device; and
providing use of the adjusted or recorded load for determining one or more uplink resources to be used by the wireless device.

24. The method as claimed in claim 23, wherein the identified situation comprises that the second cell of the second type is added to an active set list that comprises no cells of the second type, the active set list being a list associated with one or more cells to which the wireless device is at least partly connected.

25. The method as claimed in claim 24, wherein the adjustment of the load is in response to the second cell being added to the active set list.

26. The method as claimed in claim 23, wherein the adjustment of the load is based on a measure of an imbalance between the first cell, which is a serving cell, and the second cell, wherein the imbalance is experienced by the wireless device.

27. The method as claimed in claim 23, wherein the identified situation comprises that the wireless device switches serving cell from the first cell to the second cell.

28. The method as claimed in claim 27, wherein the identified situation further comprises that a restriction is associated with an uplink power control when the wireless device is served by the first cell, wherein the restriction comprises that one or more uplink channels are solely controlled by the first cell as a serving cell.

29. The method as claimed in claim 27, wherein the recording of the load in the first cell is before the wireless device switches serving cell to the second cell and the use of the recorded load is provided in response to switching to the second cell.

30. The method as claimed in claim 23, wherein the provided use of the adjusted or recorded load comprises that the adjusted or recorded load is used in a load headroom to power offset mapping, wherein the load headroom to power offset mapping is used for determining the one or more uplink resources to be used by the wireless device.

31. The method as claimed in claim 23, wherein the use of the recorded load is stopped in response to determining that a difference between a current load, in the uplink between the wireless device and the second cell, and the recorded load equals or is below a threshold value.

32. The method as claimed in claim 23, wherein the use of the adjusted or recorded load is stopped in response to determining that the second cell stops sending consecutive transmit power control (TPC) commands to the wireless device, wherein the consecutive commands consecutively command the wireless device to decrease power.

33. A non-transitory computer readable medium storing a computer program for managing uplink resources to be used by a wireless device, the computer program comprising instructions that, when executed by a processing circuit of a network node in a wireless communication network comprising cells for serving the wireless device, the cells forming at least one imbalance region in which the wireless device has the best quality in the downlink to a first cell of a first type and in the uplink to a second cell of a different, second type, cause the network node to:
identify a situation associated with a risk of an undesired decrease of transmit power used by the wireless device when the wireless device moves in the imbalance region;
provide, in response to the identification, at least one of adjustment and recording of a load in the uplink between the wireless device and the first cell, wherein the load is associated with a reference channel and used for determining one or more uplink resources to be used by the wireless device; and
provide use of the adjusted or recorded load for determining one or more uplink resources to be used by the wireless device.

34. A network node configured for managing uplink resources to be used by a wireless device in a wireless communication network comprising cells for serving the wireless device, the cells forming at least one imbalance region in which the wireless device has the best quality in the downlink to a first cell of a first type and in the uplink to a second cell of a different, second type, wherein the network node comprises:
communication circuitry configured for directly or indirectly communicating with other nodes or devices in the wireless communication network; and
processing circuitry operatively associated with the communication circuitry and configured to:
identify a situation associated with a risk of an undesired decrease of transmit power used by the wireless device when the wireless device moves in the imbalance region;
provide, in response to the identification, at least one of adjustment and recording of a load in the uplink between the wireless device and the first cell, wherein the load is associated with a reference channel and used for determining one or more uplink resources to be used by the wireless device; and
provide use of the adjusted or recorded load for determining one or more uplink resources to be used by the wireless device.

35. The network node as claimed in claim 34, wherein the identified situation comprises that the second cell of the second type is added to an active set list that comprises no cells of the second type, the active set list being a list associated with one or more cells to which the wireless device is at least partly connected.

36. The network node as claimed in claim 35, wherein the adjustment of the load is in response to the second cell being added to the active set list.

37. The network node as claimed in claim 34, wherein the adjustment of the load is based on a measure of an imbalance between the first cell, which is a serving cell, and the second cell, wherein the imbalance is experienced by the wireless device.

38. The network node as claimed in claim 34, wherein the identified situation comprises that the wireless device switches serving cell from the first cell to the second cell.

39. The network node as claimed in claim 38, wherein the identified situation further comprises that a restriction is associated with an uplink power control when the wireless device is served by the first cell, wherein the restriction comprises that one or more uplink channels are solely controlled by the first cell as serving cell.

40. The network node as claimed in claim 38, wherein the record of the load in the first cell is before the wireless device switches serving cell to the second cell and the use of the recorded load is provided in response to switching to the second cell.

41. The network node as claimed in claim 34, wherein the provided use of the adjusted or recorded load comprises that the adjusted or recorded load is used in a load headroom to power offset mapping, wherein the load headroom to power offset mapping is used for determining the one or more uplink resources to be used by the wireless device.

42. The network node as claimed in claim 34, wherein the use of the recorded load is stopped in response to determining that a difference between a current load, in the uplink between the wireless device and the second cell, and the recorded load equals or is below a threshold value.

43. The network node as claimed in claim 34, wherein the use of the adjusted or recorded load is stopped in response to determining that the second cell stops sending consecutive transmit power control (TPC) commands to the wireless device, wherein the consecutive commands consecutively command the wireless device to decrease power.
